(19) United States
(12) Patent Application Publication
(10) Pub. No.: US 2010/0123006 A1
(43) Pub. Date: May 20, 2010

(54) CARD READER

(75) Inventor: I-Ming Chen, Taipei City (TW)

Correspondence Address: SINGIM INTERNATIONAL CORP, P.O. BOX 108-00403, TAIPEL 106, TW

(73) Assignee: SINGIM INTERNATIONAL CORP., Taipei Hsien (TW)

(21) Appl. No.: 12/271,937

(22) Filed: Nov. 17, 2008

(51) Int. Cl. G06K 7/06; H01R 13/648

(52) U.S. Cl. 235/441; 439/607.01

(57) ABSTRACT

A card reader is disclosed to include a body, which has a USB plug at one end and an insertion slot at the other end for the insertion of an electronic card, an adapter, which is receivable in a top accommodation open chamber of the body and has a Micro-USB plug and a Mini-USB plug at two opposite sides, and a transmission line, which is receivable with the adapter in the top accommodation open chamber of the body and has a first connection terminal electrically connected to a circuit board inside the body and a second connection terminal inserted into a base of the adapter and electrically connected with the Micro-USB plug and the Mini-USB plug. An electronic apparatus to which the USB plug or the Micro-USB plug or Mini-USB plug of the adapter is connected can fetch data from an electronic card that is inserted into the insertion slot.

### BACKGROUND OF THE INVENTION

1. Field of the Invention

The present invention relates to a card reader and more particularly, to such a card reader, which comprises a body with a USB plug and a memory card insertion slot, and an adapter, which is provided with a Micro-USB plug and a Mini-USB plug and connected to a circuit board in the body through a transmission line and receivable with the transmission line in a top accommodation open chamber in the top side of the body.

2. Description of the Related Art

Following fast development of modern technology, many innovative electronic products have been created and have appeared on the market. In the present digital era, there is variety of electronic products, such as digital TV, digital audio system, MP3, digital camera, electronic dictionary, PDA and the like employ digital technology. Further, many digital products store, fetch or update data by means of a memory card. In order to read data from a memory card, a card reader is necessary. Further, to facilitate carrying, modern electronic products are made having light, thin, short and small characteristics. To minimize the dimension of an electronic product, the internal component parts must be made as small as possible. In consequence, small-sized memory cards are created.

Conventional memory cards are numerous, including MMC (MultiMedia Card), CF (Compact Flash Card), SMC (SmartMedia Card), MS (Memory Stick) and SD (Secure Digital Memory Card). Nowadays, many other small-sized cards such as Mini SD, MS Duo and Trans Flash (Micro SD) are commercially available.

Further, a card reader is an interface between a memory card and a computer. By means of hot-plug technology, a card reader can rapidly transfer data from a memory card to a computer immediately after its insertion into a USB (Universal Serial Bus) port of the computer. However, conventional card readers commonly have a big size and a heavy weight, and are not convenient for carrying. Due to big size, a conventional card reader cannot be directly connected to the USB port of the computer. A USB cable is necessary when connecting a card reader to a computer. Preparing a USB cable requires extra cost.

Further, a regular card reader has only one single connection interface (for example, USB interface) for connection to a matching port of an electronic apparatus. Because the connection interface of a card reader is predetermined, conventional card readers are not expandable. To connect a card reader to an electronic device that does not provide any compatible connection port, an adapter interface device shall be used. It is inconvenient to use and keep a card reader with an adapter. The use of an adapter with a card reader relatively increases the cost.

Therefore, it is desirable to provide a card reader that eliminates the aforesaid problems.

### SUMMARY OF THE INVENTION

The present invention has been accomplished under the circumstances in view. It is one object of the present invention to provide a card reader, which is compatible to different interface formats. It is another object of the present invention to provide a card reader, which is easy and convenient to use. It is still another object of the present invention to provide a card reader, which has a wide application range and significant added value and light, thin, short and small characteristics, attracting consumers to purchase.

To achieve these and other objects of the present invention, a body, which comprises a top accommodation open chamber formed in the top side, a circuit board mounted in the inside, an insertion slot formed in the rear side for the insertion of an electronic card into connection with the circuit board, and a USB plug extending out of the front side and electrically connected to the circuit board, an adapter, which is receivable in the top accommodation open chamber of the body, comprising a base, a Micro-USB plug extending out of one side of the base, and a Mini-USB plug extending out of an opposite side of the base, and a transmission line, which is receivable with the adapter in the top accommodation open chamber, comprising a first connection terminal electrically connected to the circuit board and a second connection terminal inserted into the base of the adapter and electrically connected with the Micro-USB plug and the Mini-USB plug.

Further, the body has a receiving groove and a retaining hole respectively located on front and rear sides of the top accommodation open chamber for the positioning of the Micro-USB plug and the Mini-USB plug respectively when the adapter is mounted into the top accommodation open chamber, avoiding accidental damage.

### BRIEF DESCRIPTION OF THE DRAWINGS

FIG. 1 is an oblique top elevation of a card reader in accordance with the present invention.

FIG. 2 is an exploded view of the card reader in accordance with the present invention.

FIG. 3 corresponds to FIG. 2 when viewed from another angle.

FIG. 4 is another exploded view of the card reader in accordance with the present invention, showing the design of the insertion slot in the top cover shell and the arrangement of the contact terminals at the circuit board for the connection of an electronic card.

FIG. 5 is a cutaway view of the card reader in accordance with the present invention.

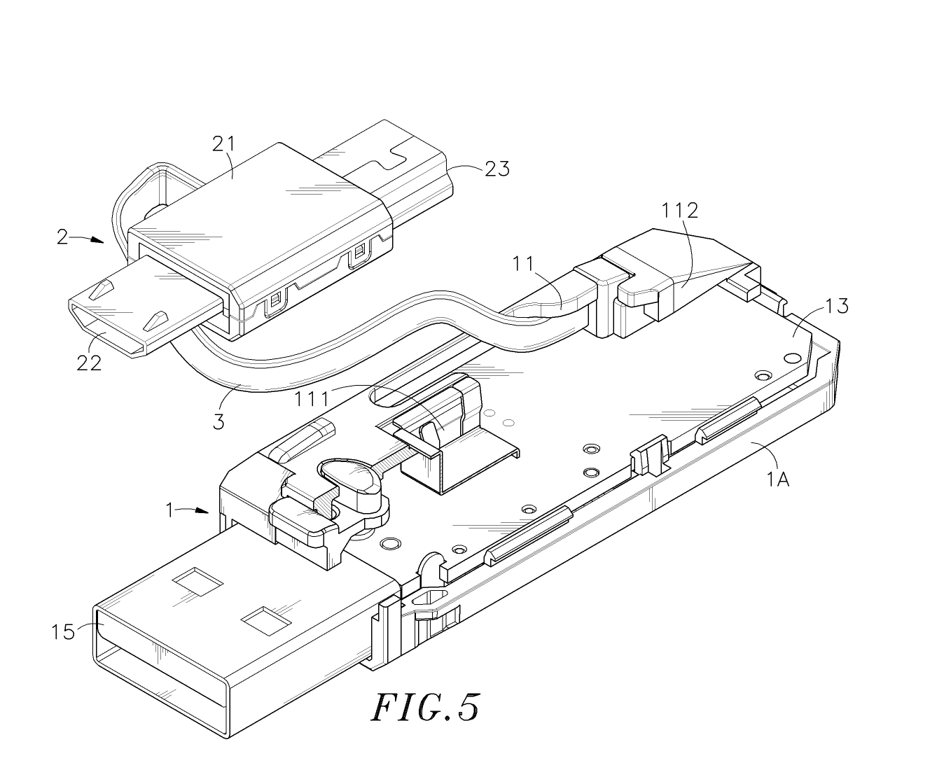

FIG. 6 is a schematic drawing showing an application example of the present invention.

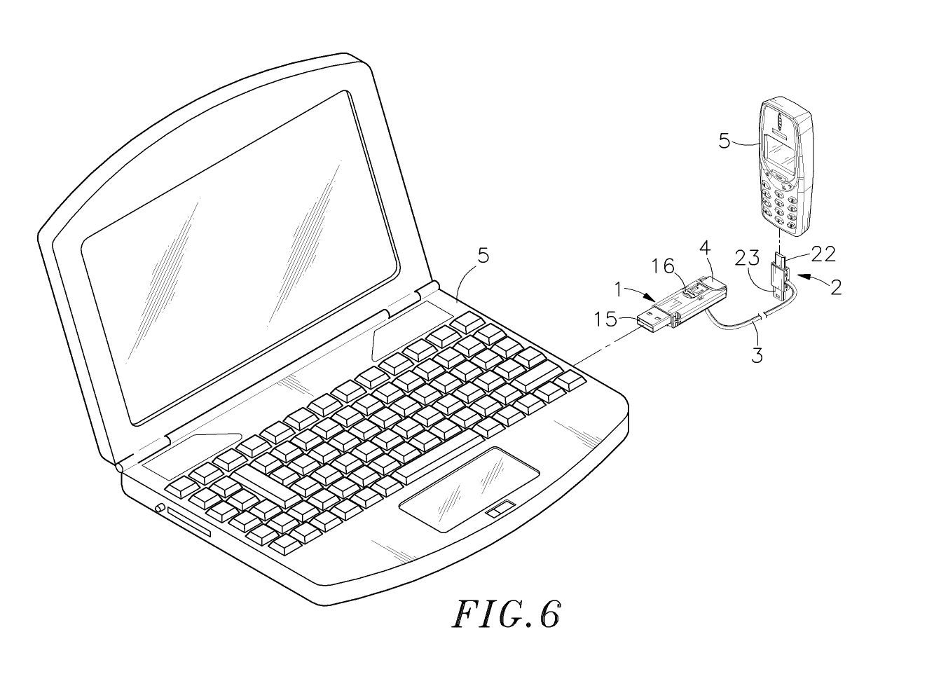

### DETAILED DESCRIPTION OF THE PREFERRED EMBODIMENT

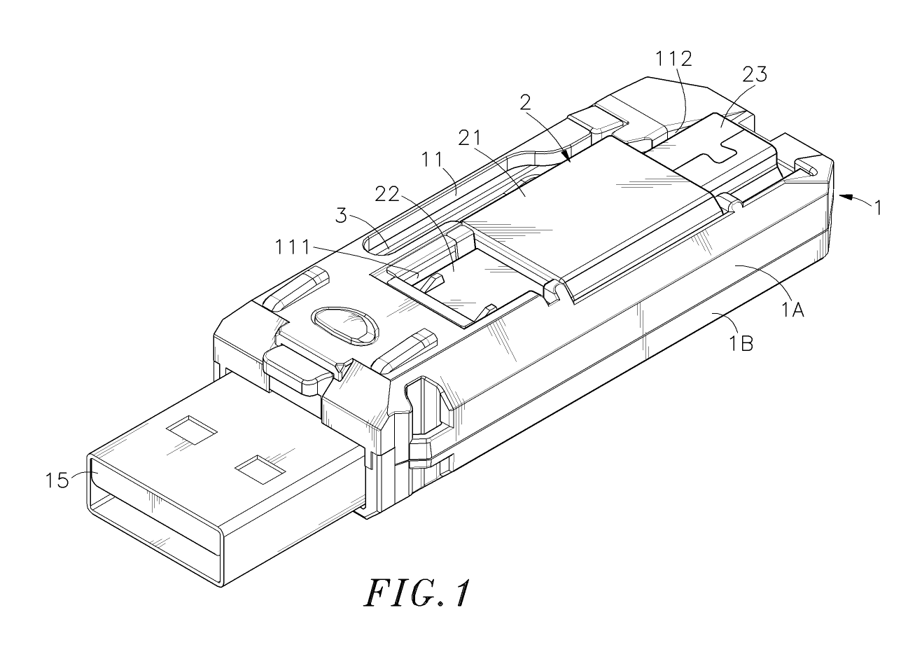

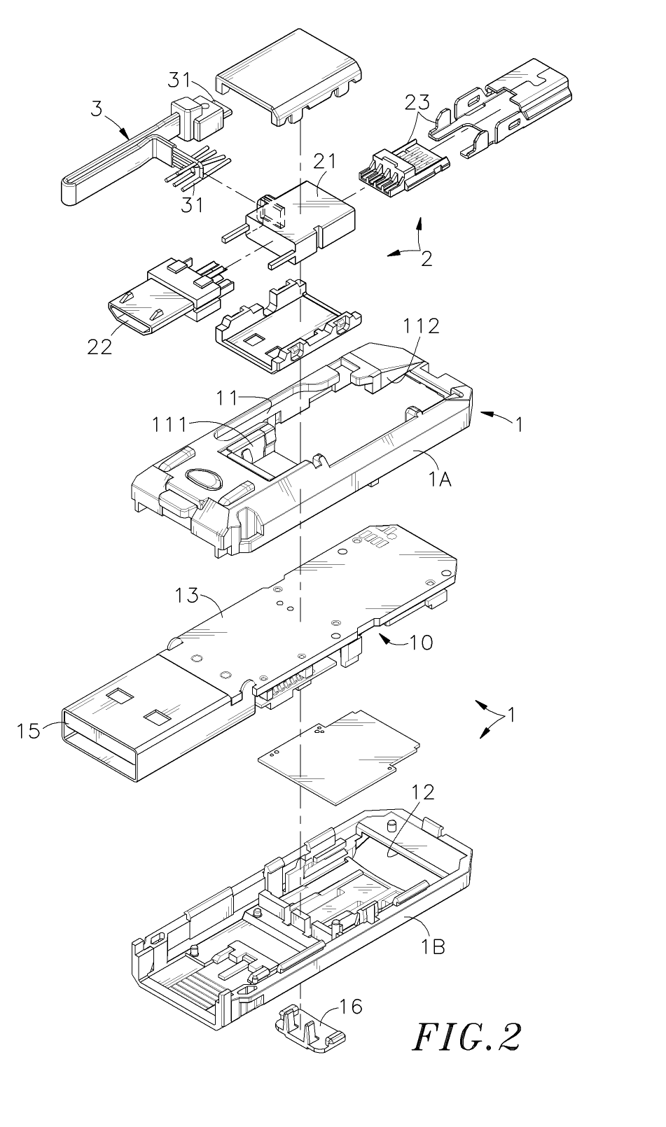

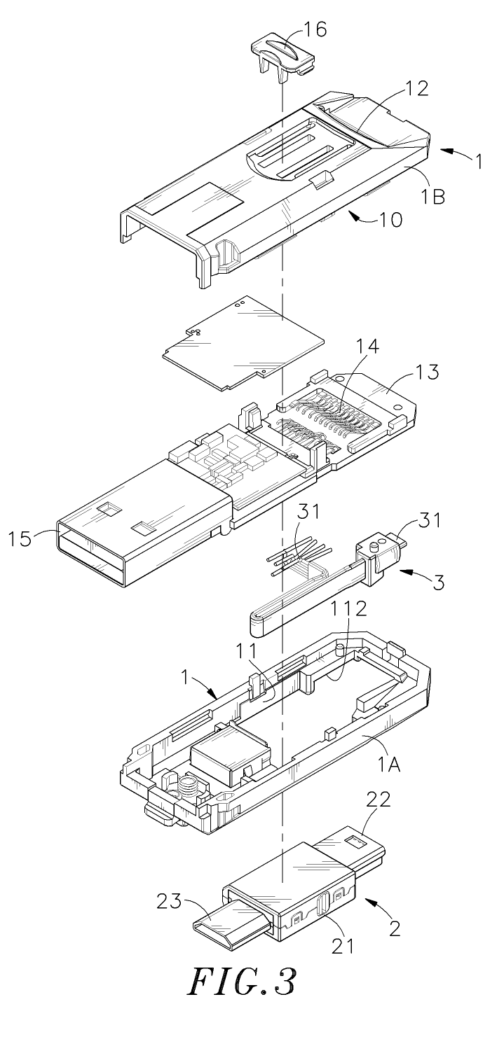

Referring to FIGS. 1-3, a card reader in accordance with the present invention is shown comprised of a body 1, an adapter 2 and a transmission line 3.

The body 1 has a top accommodation open chamber 11 in its top side for accommodating the adapter 2, an inside accommodation chamber 10 defined on the inside, an insertion slot 12 disposed at its one end in communication with the inside accommodation chamber 10 for the insertion of an electronic card 4, a circuit board 13 mounted in the inside accommodation chamber 10 and carrying related electronic component parts, and a USB plug 15 electrically connected to the circuit board 13 and extending out of the other end of the body 1 opposite to the insertion slot 12. The body 1 further has a front retaining groove 111 and a rear retaining hole 112 in the front and rear sides of the top accommodation open chamber 11. Further, the circuit board 13 has a set of contact terminals 14 for the contact of contacts 41 of an electronic card 4 that is inserted into the insertion slot 12.

The adapter 2 has a Micro-USB plug 22 and a Mini-USB plug 23 respectively extending from front and rear ends of its base 21. When the adapter 2 is mounted into the top accommodation open chamber 11 of the body 1, the Micro-USB plug 22 and the Mini-USB plug 23 are respectively fitted into the front retaining groove 111 and the rear retaining hole 112 in the top accommodation open chamber 11, and therefore the adapter 2 is firmly secured in place in the top accommodation open chamber 11.

The transmission line 3 has two connection terminals 31 respectively extended from its two distal ends and respectively electrically connected to the circuit board 13 and the base 21 of the adapter 2. The connection terminal 31 that is inserted into the base 21 of the adapter 2 is electrically connected with the Micro-USB plug 22 and the Mini-USB plug 23.

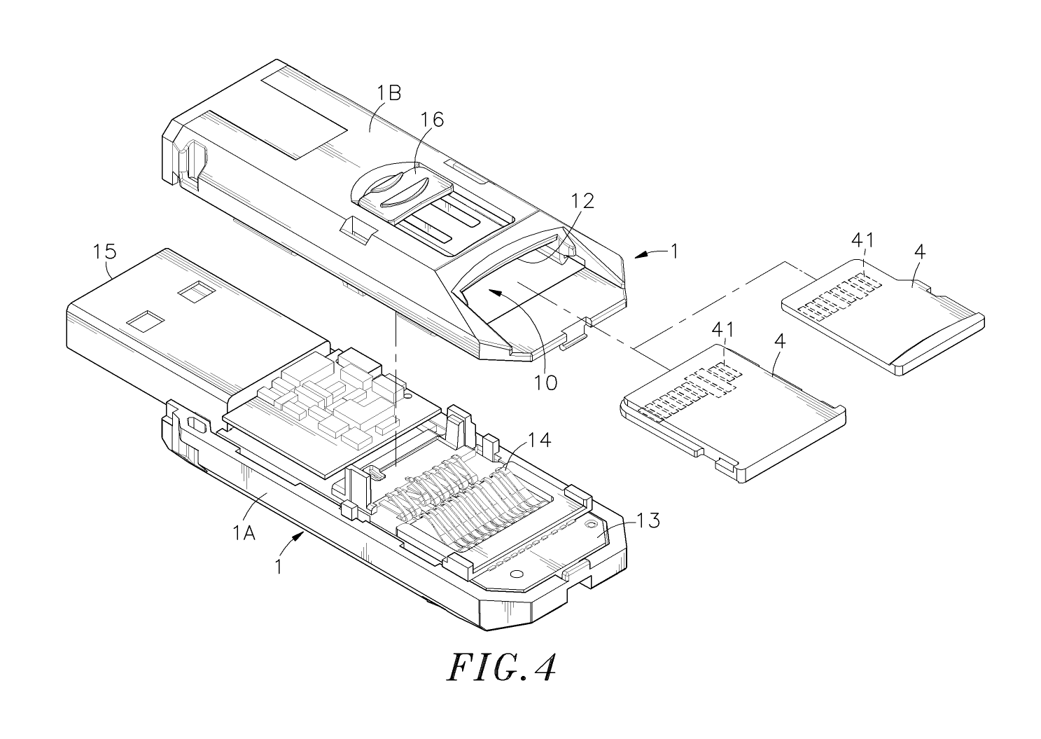

The electronic component parts of the circuit board 13 include a first chip adapted to receive and process signals from the adapter 2 and a second chip adapted to receive and process signals from an electronic card 4 that is inserted into the insertion slot 12. The first chip has electrically connected thereto an antenna and LEDs (light emitting diodes). Further, the body 1 is formed of a top cover shell 1A and a bottom cover shell 1B that surround the circuit board 13. The top accommodation open chamber 11 is formed in the top cover shell 1A of the body 1. The circuit board 13 is mounted in the bottom cover shell 1B of the body 1. The insertion slot 12 is formed in one end of the bottom cover shell 1B. Further, a card ejector 16 is mounted in the bottom cover shell 1B and movable to eject the inserted electronic card 4 out of the inside accommodation chamber 10 (see FIG. 4).

During installation of the card reader, the contact terminals 14 are installed in the circuit board 13, and then the USB plug 15 is mounted in the front side of the circuit board 13 and the pins of the USB plug 15 are soldered to respective contacts of the circuit board 13. Thereafter, one connection terminal 31 of the transmission line 3 is soldered to surface contacts of the circuit board 13, and then the other connection terminal 31 of the transmission line 3 is inserted into the base 21 of the adapter 2 and respectively electrically soldered to the contact pins of the Micro-USB plug 22 and the contact pins of the Mini-USB plug 23. After installation of the transmission line 3, the connection terminal 31 and the adapter 2 show a substantially T-shaped connection configuration. Thereafter, the top cover shell 1A and bottom cover shell 1B of the body 1 are fastened together to surround the circuit board 13, keeping USB plug 15 exposed to the outside of the body 1. Thereafter, the transmission line 3 is received with the adapter 2 in the top accommodation open chamber 11.

When the adapter 2 is received in the top accommodation open chamber 11 in the top side of the body 1, the Micro-USB plug 22 and the Mini-USB plug 23 of the adapter 2 are respectively fitted into the front retaining groove 111 and the rear retaining hole 112 in the front and rear sides of the top accommodation open chamber 11, and therefore the adapter 2 is received in the body 1 convenient for carrying. Because the adapter 2 is receivable in the body 1, carrying the adapter 2 does not increase the original design dimension of the card reader. Therefore, the card reader has light, thin, short and small characteristics. Further, positioning the Micro-USB plug 22 and the Mini-USB plug 23 in the front retaining groove 111 and the rear retaining hole 112 of the body 1 avoids accidental damage due to protrusion over the body 1.

Referring to FIGS. 4˜6, the card reader can be electrically connected to any of a variety of electronic apparatuses 5 for storing data. When in use, an electronic card 4 is inserted into the insertion slot 12. At this time, the contacts 41 of the electronic card 4 are kept in contact with the contacts 14 of the circuit board 13. Thereafter, pull the adapter 2 out of the body 1, and then connect the USB plug 15 of the body 1 or the Micro-USB plug 22 or the Mini-USB plug 23 of the adapter 2 to an electronic apparatus 5, allowing the electronic apparatus 5 to read data from the electronic card 4 or to store data in the electronic card 4 via the card reader. Further, the electronic apparatus 5 can be a desk computer, notebook computer, PDA, cell phone or multipurpose office machine. The electronic card 4 can be a Mini SD, MS Duo, Trans Flash (Micro SD), CF (Compact Flash), SD (Secure Digital) or SM (SmartMedia) memory card.

Further, the body 1 can be made by means of an injection molding technique to mold a plastic shell that surrounds the circuit board 13 and a part of the USB plug 15. Further, a USB socket may be used to substitute for the USB plug 15. By means of the top accommodation open chamber 11 to receive the adapter 2 and the insertion slot 12 to receive an electronic card 4, the card reader saves space and facilitates carrying. Therefore, the card reader of the present invention has light, thin, short and small characteristics.

As stated above, the Micro-USB plug 22 and the Mini-USB plug 23 of the adapter 2 are respectively provided at two opposite sides of the base 21. Further, the connection terminal 31 of the transmission line 3 that is inserted into the base 21 is split into two terminal portions that are respectively connected to the contact pins of the Micro-USB plug 22 and the contact pins of the Mini-USB plug 23 so that the Micro-USB plug 22 or the Mini-USB plug 23 can be directly used for signal transmission without through an electric device. Further, the interface format of the Micro-USB plug 22 and the interface format of the Mini-USB plug 23 can be converted by a control IC in the circuit board 13 for data transmission between the card reader and an external electronic apparatus.

Further, in the aforesaid preferred embodiment, the adapter 2 has the Micro-USB plug 22 and the Mini-USB plug 23 respectively provided at two opposite sides of the base 21. However, this design is not a limitation. The adapter 2 can be configured to have other interface connectors provided at two sides of the base 21. The main feature of the present invention is the design of the top accommodation open chamber 11 in the body 1 for accommodating the adapter 2.

In general, the invention provides a card reader, which has the features and advantages as follows.

The card reader comprises a body 1 with a USB plug 15, an adapter 2 receivable in a top accommodation open chamber 11 in the top side of the body 1 and having a Micro-USB plug 22 and a Mini-USB plug 23 disposed at two opposite sides, and a transmission line 3 receivable with the adapter 2 in the top accommodation open chamber 11 of the body 1 and having two connection terminals 31 disposed at the two opposite ends with one connection terminal 31 electrically connected to a circuit board 13 in the body 1 and the other connection terminal 31 inserted into a base 21 of the adapter 2 and electrically connected with the Micro-USB plug 22 and the Mini-USB plug 23. Further, the body 1 has an insertion slot 12 for allowing an electronic card 4 to be inserted into the card reader and forced into contact with contact terminals 14 of the circuit board 13. By means of the USB plug 15, the Micro-USB plug 22 or the Mini-USB plug 23, the card reader can be connected to any of a variety of electronic apparatuses 5 for enabling the connected electronic apparatus 5 to read data from the electronic card 4 that is inserted into the insertion slot 12. Because the card reader made according to the present invention is compatible to different interface connectors, it has a wide application range and significant added value, attracting consumers to purchase.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A card reader, comprising:
a body, said body comprising a top accommodation open chamber formed in a top side thereof, an inside accommodation chamber, a circuit board mounted in said inside accommodation chamber, said circuit board comprising a set of contact terminals, an insertion slot formed in one end thereof in communication with said inside accommodation chamber for the insertion of an electronic card into contact with said contact terminals of said circuit board, and a USB plug extending out of a front side thereof and electrically connected to said circuit board and electrically connectable to an external electronic apparatus;
an adapter receivable in said top accommodation open chamber of said body, said adapter comprising a base, a Micro-USB plug extending out of one side of said base, and a Mini-USB plug extending out of an opposite side of said base; and
a transmission line receivable with said adapter in said top accommodation open chamber, said transmission line comprising a first connection terminal extended from one end thereof and electrically connected to said circuit board and a second connection terminal extended from an opposite end thereof and inserted into said base of said adapter and electrically connected with said Micro-USB plug and said Mini USB plug.

2. The card reader as claimed in claim 1, wherein said body comprises a receiving groove and a retaining hole respectively located on front and rear sides of said top accommodation open chamber for the positioning of said Micro-USB plug and said Mini USB plug respectively.

3. The card reader as claimed in claim 1, wherein said circuit board comprises a plurality of IC chips controllable to receive and process signals from said adapter and an electronic card that is inserted into said insertion slot and forced into contact with said contact terminals of said circuit board.

4. The card reader as claimed in claim 1, wherein said body comprises a top cover shell and a bottom cover shell fastened together to surround said circuit board and a part of said USB plug; said top accommodation open chamber is formed in said top cover shell; said circuit board is fixedly mounted inside said bottom cover shell; said insertion slot is formed in one end of said bottom cover shell.

5. The card reader as claimed in claim 1, wherein said body comprises a card ejector movable to eject an inserted electronic card out of said inside accommodation chamber.

6. The card reader as claimed in claim 1, wherein said second connection terminal inserted into said base of said adapter and electrically connected with said Micro-USB plug and said Mini USB plug shows a T-shaped connection configuration.

7. The card reader as claimed in claim 1, wherein said second connection terminal is split into two terminal portions that are respectively connected to contact pins of said Micro-USB and contact pins of said Mini-USB plug.

8. The card reader as claimed in claim 1, wherein said insertion slots allows insertion of one of a group of Mini SD, MS Duo and Trans Flash (Micro SD) memory cards.
